(19) United States
(12) Patent Application Publication
(10) Pub. No.: US 2017/0344976 A1
(43) Pub. Date: Nov. 30, 2017

(54) SIMPLE MOBILE PAYMENT SYSTEM

(71) Applicant: MCPAY CORP., Seoul (KR)

(72) Inventor: Chang Ju LEE, Seoul (KR)

(73) Assignee: MCPAY CORP., Seoul (KR)

(21) Appl. No.: 15/245,385

(22) Filed: Aug. 24, 2016

(30) Foreign Application Priority Data
May 24, 2016 (KR) 10-2016-0063717

(51) Int. Cl. G06Q 20/32; G06Q 20/10; G06Q 20/20; H04W 52/34

(52) U.S. Cl. CPC G06Q 20/3278; H04W 52/34; G06Q 20/10; G06Q 20/204

(57) ABSTRACT

Provided is a simple mobile payment system, in which two near-field communication (NFC) antennae are included in one NFC device to link the NFC device to an affiliated store payment terminal and mobile order and payment are handled in an easy and simple manner by switching between the two NFC antennae using a switching technique, thereby decreasing system complexity and manufacturing costs.

### CROSS-REFERENCE TO RELATED APPLICATION(S)

This application claims priority from Korean Patent Application No. 10-2016-0063717, filed on May 24, 2016, in the Korean Intellectual Property Office, the disclosure of which is incorporated herein by reference in its entirety.

### BACKGROUND

### 1. Field

The following description relates to a simple mobile payment technique, and particularly, to a simple mobile payment system in which a near-field communication (NFC) device including a multi-antenna is linked to an affiliated store payment terminal.

### 2. Description of Related Art

In Android phones, a near-field communication (NFC) function is open and thus payment may be made using the NFC function. In contrast, in iPhones, although the NFC function is included, the NFC function is not open according to Apple's policies and thus user inconvenience is caused since payment is made using barcode or quick-response (QR) code.

Korean patent publication application No. 10-2015-0138869, filed on Dec. 11, 2015, discloses a payment technique, in which a payment terminal device provides menu information to a mobile terminal device and receives an order from the mobile terminal device when the mobile terminal device is located at a first position (when identified by a first NFC device), and processes payment for an order when the mobile terminal device is located at a second position (identified by a second NFC device).

When a plurality of NFC devices are individually manufactured and installed at different positions, a mobile payment system is complicated and manufacturing costs thereof increase. Thus, the inventor of the present application conducted research on a simple mobile payment system, in which two NFC antennae are included in one NFC device to link the NFC device to an affiliated store payment terminal and mobile order and payment are handled in an easy and simple manner by switching between the two NFC antennae using a switching technique, thereby decreasing system complexity and manufacturing costs.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a simple mobile payment system, in which two near-field communication (NFC) antennae are included in one NFC device to link the NFC device to an affiliated store payment terminal and mobile order and payment are handled in an easy and simple manner by switching between the two NFC antennae using a switching technique.

In one general aspect, a simple mobile payment system includes a near-field communication (NFC) device including a first antenna configured to cover a short-range area of several meters to several tens of meters as effective signal coverage; a second antenna configured to cover an ultra-short-range area of several centimeters to several tens of centimeters as effective signal coverage which is smaller than the effective signal coverage of the first antenna; a switch configured to switch between the first antenna and the second antenna; and a switch control unit configured to output an antenna switch command to switch to the second antenna when a payment selection event is received from an affiliated store payment terminal, and output an antenna switch command to switch to the first antenna when a payment end event is received from the affiliated store payment terminal.

In one additional aspect, the NFC device further includes a transmission power control unit configured to limit transmission power of the first antenna and the second antenna.

In one additional aspect, the first antenna emits affiliated store identification (ID) information to the short-range area.

In one additional aspect, the first antenna receives client ID information from a mobile user equipment (UE) which receives the affiliated store ID information in the short-range area.

In one additional aspect, the first antenna emits information regarding products to the mobile UE corresponding to the client ID information in the short-range area, and receives order information from the mobile UE receiving the information regarding products.

In one additional aspect, the second antenna receives payment information from the ultra-short-range area.

In one additional aspect, the NFC device is configured in the form of signpad.

In one additional aspect, the NFC device is configured in the form of dongle.

In one additional aspect, the simple mobile payment system further includes an affiliated store payment terminal including an event generator configured to generate the payment selection event or the payment end event; and an event transmitter configured to transmit the payment selection event or the payment end event generated by the event generator to the NFC device.

In one additional aspect, the affiliated store payment terminal further includes an information provider configured to receive client ID information from the NFC device, relay the client ID information to a management server, receive information regarding products corresponding to the client ID information from the management server, and transmit the information regarding products to the NFC device.

In one additional aspect, the information regarding products includes product menu information, point information, discount information, and coupon information.

In one additional aspect, the affiliated store payment terminal further includes an order processor configured to store order information when the order information is received from the NFC device, and requests the event generator to generate the payment selection event when payment for the order information is selected by a franchiser.

In one additional aspect, the affiliated store payment terminal further includes a payment processor configured to receive payment information from the NFC device, handle authorization for the payment information, transmit a result of handling authorization for the payment information to the NFC device, and request the event generator to generate the payment end event after payment is made.

In one additional aspect, the simple mobile payment system further includes a mobile user equipment (UE) configured to run a simple payment application which operates in an order mode when the mobile UE is positioned in the short-range area and operates in a payment mode when the mobile UE is positioned in the ultra-short-range area.

In one additional aspect, the simple payment application includes a product information receiver configured to transmit client identification (ID) information to the NFC device and receive information regarding products from a management server when affiliated store ID information is received via the first antenna of the NFC device; an order request unit configured to generate order information by receiving at least one product menu selected from the information regarding products, which is received by the product information receiver, from a user, and to transmit the generated order information via the first antenna of the NFC device; and a payment performing unit configured to determine a distance to the NFC device, run a payment interface when the mobile UE enters the ultra-short-range area, receive payment information from the user via the payment interface, transmit the payment information via the second antenna of the NFC device, and receive a result of authorizing payment from the NFC device.

Other features and aspects will be apparent from the following detailed description, the drawings, and the claims.

### BRIEF DESCRIPTION OF THE DRAWINGS

FIG. 1 is a schematic network diagram illustrating an example of a simple mobile payment system;

FIG. 2 is a block diagram of an example of a near-field communication (NFC) device of the simple mobile payment system;

FIG. 3 is a block diagram of an example of an affiliated store payment terminal of the simple mobile payment system;

FIG. 4 is a block diagram of an example of a simple payment application installed in a mobile user equipment (UE) of the simple mobile payment system;

FIG. 5 is a flowchart illustrating an example of an order procedure performed by the simple mobile payment system; and

FIG. 6 is a flowchart illustrating an example of a payment procedure performed by the simple mobile payment system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The terms used in the present disclosure are defined in consideration of the functions of exemplary embodiments but may be changed according to a user's intention, an operator's intention, precedents, etc. Thus, these terms should be defined based on the whole context of the present disclosure.

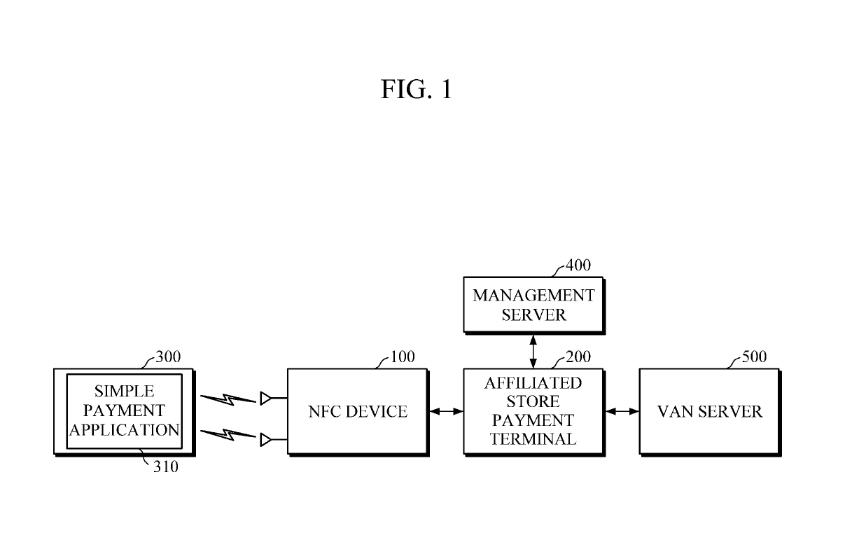

FIG. 1 is a schematic network diagram illustrating a simple mobile payment system according to an exemplary embodiment of the present invention. As illustrated in FIG. 1, the simple mobile payment system according to the present embodiment includes a near-field communication (NFC) device 100, an affiliated store payment terminal 200, a mobile user equipment (UE) 300, a management server 400, and a value-added network (VAN) server 500.

The NFC device 100 is linked to the affiliated store payment terminal 200 via wire or wirelessly, includes two antennae, and performs NFC or ultra-NFC by switching between the two antennae according to an event received from the affiliated store payment terminal 200. In NFC, a short-range area of several meters to several tens of meters is covered as effective signal coverage. In ultra-NFC, an ultra-short-range area of several centimeters to several tens of centimeters is covered as effective signal coverage.

The affiliated store payment terminal 200 is linked to the NFC device 100 via wire or wirelessly, and transmits an event for antenna switching to the NFC device 100, provides information regarding products and performs a procedure of receiving order information through NFC covering a short-range area of several meters to several tens of meters as effective signal coverage, and performs a payment process procedure through ultra-NFC covering an ultra-short-range area of several centimeters to several tens of centimeters as effective signal coverage.

In this case, the affiliated store payment terminal 200 and the NFC device 100 may be linked to each other according to a wire communication method such as universal serial bus (USB) serial communication or a wireless communication method such as Bluetooth. The affiliated store payment terminal 200 may be a point-of-sale (POS) terminal, a credit authorization (CAT), or the like.

The mobile UE 300 performs NFC covering a short-range area of several meters to several tens of meters as effective signal coverage or ultra-NFC covering an ultra-short-range area of several centimeters to several tens of centimeters as effective signal coverage with the NFC device 100, and includes a simple payment application 310 configured to make an order or payment. Thus, an order or payment is made using the simple payment application 310.

In this case, payment may be made by the mobile UE 300 using various mobile card payment techniques, e.g., Payco, an application card which is a simple payment application manufactured by a credit card company, WeChat which is an overseas payment application, Alibaba or Tencent which is a simple payment application using a smart phone, an application card payment method using a one-time card-number (OTC), etc.

The management server 400 stores and manages information regarding products to be provided to the mobile UE 300. For example, the information regarding products may include product menu information, point information, discount information, and coupon information.

In this case, the management server 400 may be configured to directly provide the information regarding products to the mobile UE 300 through wireless communication such as 3G, LTE, or Wi-Fi, or may be configured to relay the information regarding products to the mobile UE 300 via the affiliated store payment terminal 200.

The VAN server 500 handles authorization for payment requested by the mobile UE 300 and relayed via the affiliated store payment terminal 200, and provides a result of handling authorization for the payment to the mobile UE 300 via the affiliated store payment terminal 200.

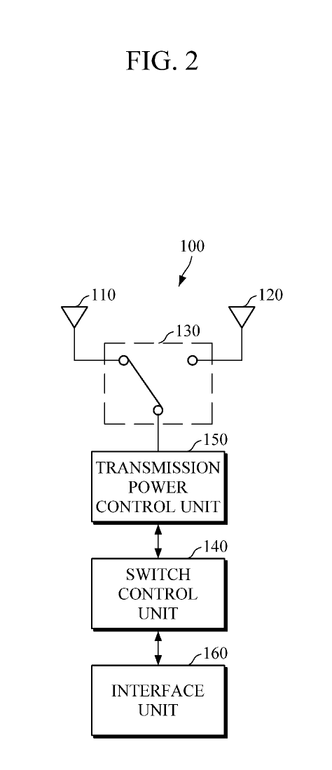

FIG. 2 is a block diagram of an NFC device of a simple mobile payment system according to an exemplary embodiment of the present invention. The NFC device 100 of the simple mobile payment system according to an exemplary embodiment of the present invention may be configured in the form of Signpad or Dongle, and linked to the affiliated store payment terminal 200 through a wire communication method such as USB serial communication or a wireless communication method such as Bluetooth.

As illustrated in FIG. 2, the NFC device 100 according to the present embodiment includes a first antenna 110, a second antenna 120, a switch 130, and a switch control unit 140.

The first antenna 110 covers a short-range area of several meters to several tens of meters as effective signal coverage, and emits affiliated store identification (ID) information to the short-range area. For example, the affiliated store ID information may be a series of unique code of each affiliated store which consists of numbers, characters, or a combination thereof.

A user who is positioned in a short-range area of several meters to several tens of meters from the NFC device 100 receives the affiliated store ID information emitted via the first antenna 110 of the NFC device 100 from the NFC device 100 via the mobile UE 300 which the user carries with him/herself. In this case, in the mobile UE 300, the simple payment application 310 receives the affiliated store ID information since an NFC function is activated and the simple payment application 310 is run in a background.

The simple payment application 310 which is run in the mobile UE 300 receiving the affiliated store ID information transmits client ID information to the NFC device 100. Then the first antenna 110 of the NFC device 100 receives the client ID information from the mobile UE 300 which receives the affiliated store ID information in the short-range area. In this case, the client ID information may be a mobile UE phone number.

The client ID information received via the first antenna 110 of the NFC device 100 is transmitted to the management server 400 via the affiliated store payment terminal 200, and the management server 400 provides information regarding products to the mobile UE 300.

In this case, the management server 400 may be configured to directly provide the information regarding products to the mobile UE 300 through wireless communication such as 3G, LTE, or Wi-Fi, or may be configured to relay the information regarding the products to the mobile UE 300 via the affiliated store payment terminal 200.

When the management server 400 relays the information regarding products to the mobile UE 300 via the affiliated store payment terminal 200, the first antenna 110 of the NFC device 100 emits the information regarding products transmitted from the affiliated store payment terminal 200 to the mobile UE 300 corresponding to the client ID information in a short-range area.

The mobile UE 300 receiving the information regarding products displays the information regarding products through the simple payment application 310, generates order information by receiving at least one product menu selected from the information regarding products from a user, and transmits the order information via the first antenna 110 of the NFC device 100. In this case, the order information may include product ID information, order quantity, etc.

The order information transmitted via the first antenna 110 of the NFC device 100 is received by the affiliated store payment terminal 200, and a payment process is performed via the second antenna 120 of the NFC device 100.

The second antenna 120 covers an ultra-short-range area of several centimeters to several tens of centimeters as effective signal coverage which is smaller than the effective signal coverage of the first antenna 110, and receives payment information from the ultra-short-range area.

When the mobile UE 300 transmitting the order information enters the ultra-short-range area, the mobile UE 300 provides a payment interface through the simple payment application 310, and receives payment information from a user and transmits the payment information via the payment interface. In this case, the payment information may include card information including a card number, the amount of money to be paid, etc.

The payment information transmitted from the mobile UE 300 is received via the second antenna 120 of the NFC device 100, and is transmitted to the affiliated store payment terminal 200. The affiliated store payment terminal 200 relays the payment information to the VAN server 500 to request authorization for the payment information.

The VAN server 500 handles authorization for the payment information requested by the mobile UE 300 and relayed via the affiliated store payment terminal 200, and transmits a result of handling authorization for the payment information to the affiliated store payment terminal 200.

The affiliated store payment terminal 200 receiving the result of handling authorization for the payment information from the VAN server 500 transmits this result to the mobile UE 300 via the second antenna 120 of the NFC device 100, so that this result may be displayed using the simple payment application 310 of the mobile UE 300.

The switch 130 switches between the first antenna 110 and the second antenna 120. When the switch 130 is connected to the first antenna 110, NFC covering a short-range area of several meters to several tens of meters as effective signal coverage may be conducted. When the switch 130 is connected to the second antenna 120, ultra-NFC covering an ultra-short-range area of several centimeters to several tens of centimeters as effective signal coverage may be conducted.

The switch control unit 140 outputs an antenna switch command to switch to the second antenna 120 when a payment selection event is received from the affiliated store payment terminal 200, and outputs an antenna switch command to switch to the first antenna 110 when a payment end event is received from the affiliated store payment terminal 200.

Accordingly, according to an exemplary embodiment of the present invention, two NFC antennae are included in one NFC device to link the NFC device to an affiliated store payment terminal and mobile order and payment are handled in an easy and simple manner by switching between the two NFC antennae using a switching technique, thereby decreasing the complexity and manufacturing costs of a mobile payment system.

According to one additional exemplary embodiment, the NFC device 100 may further include a transmission power control unit 150. The transmission power control unit 150 limits transmission power of the first antenna 110 and the second antenna 120.

For example, the transmission power control unit 150 may be configured to limit transmission power of the first antenna 110 to set a short-range area of several meters to several tens of meters as effective signal coverage, and limit transmission power of the second antenna 120 to set an ultra-short-range area of several centimeters to several tens of centimeters as effective signal coverage.

Thus, by differently controlling transmission power of the first and second antennae 110 and 120, one NFC device 100 may support both of NFC covering a short-range area of several meters to several tens of meters as effective signal coverage and ultra-NFC covering an ultra-short-range area of several centimeters to several tens of centimeters as effective signal coverage.

According to one additional exemplary embodiment, the NFC device 100 may further include an interface unit 160. The interface unit 160 is configured to link the NFC device 100 to the affiliated store payment terminal 200 via wire or wirelessly. Through the interface unit 160, the NFC device 100 and the affiliated store payment terminal 200 may be linked to each other according to a wire communication method such as USB serial communication or a wireless communication method such as Bluetooth.

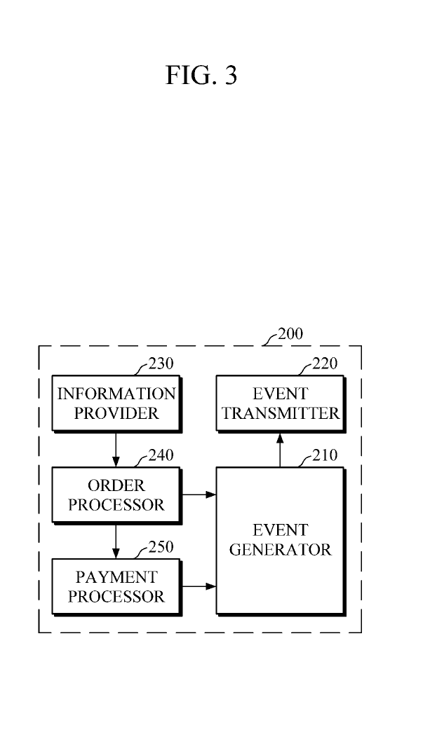

FIG. 3 is a block diagram of an affiliated store payment terminal of a simple mobile payment system according to an exemplary embodiment of the present invention. As illustrated in FIG. 3, the affiliated store payment terminal 200 of the simple mobile payment system according to the present embodiment may include an event generator 210 and an event transmitter 220.

The event generator 210 generates a payment selection event or a payment end event. For example, the event generator 210 may be configured to generate the payment selection event when the event generator 210 receives order information from the NFC device 100 and payment for the order information is selected by a franchiser.

The event generator 210 may be configured to generate the payment end event when authorization for payment information received from the NFC device 100 is completed by the VAN server 500.

The event transmitter 220 transmits the payment selection event or the payment end event generated by the event generator 210 to the NFC device 100. In the NFC device 100 receiving the payment selection event or the payment end event from the affiliated store payment terminal 200, the switch 130 switches to the second antenna 120 when the payment selection event is received, and switches to the first antenna 110 when the payment end event is received.

According to one additional exemplary embodiment, the affiliated store payment terminal 200 may further include an information provider 230. The information provider 230 receives client ID information from the NFC device 100, relays the client ID information to the management server 400, receives information regarding products corresponding to the client ID information from the management server 400, and transmits the information regarding products to the NFC device 100.

Affiliated store ID information emitted from the first antenna 110 of the NFC device 100 is received using the simple payment application 310 of the mobile UE 300. The simple payment application 310 transmits the client ID information to the affiliated store payment terminal 200 via the first antenna 110 of the NFC device 100.

Then, the client ID information is received and relayed to the management server 400 by the information provider 230 of the affiliated store payment terminal 200, and the management server 400 provides information regarding products to the mobile UE 300 corresponding to the client ID information. In this case, the information regarding products may include product menu information, point information, discount information, and coupon information.

According to one additional exemplary embodiment, the affiliated store payment terminal 200 may further include an order processor 240. When the order information is received from the NFC device 100, the order processor 240 stores the order information, and requests the event generator 210 to generate the payment selection event when payment for the order information is selected by a franchiser.

When the event generator 210 generates the payment selection event, the event transmitter 220 transmits the payment selection event to the NFC device 100. The NFC device 100 receiving the payment selection event from the affiliated store payment terminal 200 causes the switch 130 to switch to the second antenna 120 so that a payment process may be performed.

According to one additional exemplary embodiment, the affiliated store payment terminal 200 may further include a payment processor 250. The payment processor 250 receives payment information from the NFC device 100, handles authorization of the payment information, transmits a result of handling authorization of the payment information to the NFC device 100, and requests the event generator 210 to generate the payment end event after payment is made.

When the mobile UE 300 receiving the order information enters an ultra-short-range area, the mobile UE 300 provides a payment interface using the simple payment application 310, receives payment information from a user via the payment interface, and transmits the payment information. In this case, the payment information may include card information including a card number, the amount of money to be paid, etc.

The payment information transmitted from the mobile UE 300 is received via the second antenna 120 of the NFC device 100, and transmitted to the affiliated store payment terminal 200. The affiliated store payment terminal 200 relays the payment information to the VAN server 500 via the payment processor 250 to request authorization for the payment information.

The VAN server 500 handles authorization for the payment information requested by the mobile UE 300 and relayed via the affiliated store payment terminal 200, and transmits a result of handling authorization for the payment information to the affiliated store payment terminal 200.

The payment processor 250 of the affiliated store payment terminal 200 that receives the result of handling authorization for the payment information from the VAN server 500 completes payment by transmitting the result of handling authorization for the payment information to the mobile UE 300 via the second antenna 120 of the NFC device 100, and requests the event generator 210 to generate the payment end event.

When the event generator 210 generates the payment end event, the event transmitter 220 transmits the payment end event to the NFC device 100. The NFC device 100 receiving the payment end event from the affiliated store payment terminal 200 causes the switch 130 to switch to the first antenna 110 so as to emit the affiliated store ID information, provide the information regarding products, and perform an order information transmission process.

The simple payment application 310 which operates in an order mode when the mobile UE 300 is positioned in a short-range area and operates in a payment mode when the mobile UE 300 is positioned in an ultra-short-range area is installed and run in the mobile UE 300.

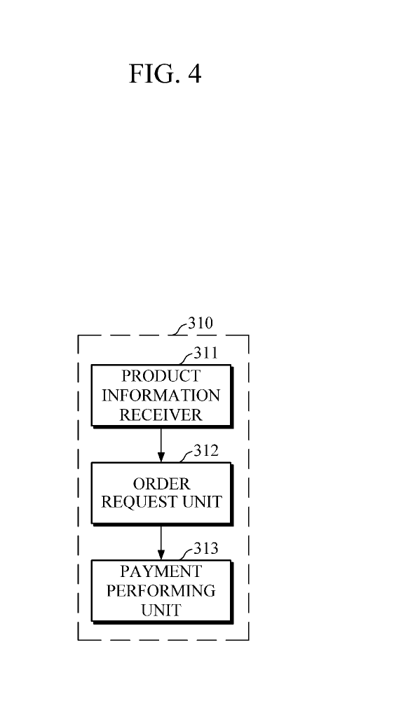

FIG. 4 is a block diagram of a simple payment application installed in a mobile UE of a simple mobile payment system according to an exemplary embodiment of the present invention. As illustrated in FIG. 4, the simple payment application 310 according to the present embodiment includes a product information receiver 311, an order request unit 312, and a payment performing unit 313.

When affiliated store ID information is received via the first antenna 110 of the NFC device 100, the product information receiver 311 transmits client ID information to the NFC device 100 and receives information regarding products from the management server 400.

The NFC device 100 emits the affiliated store ID information to a short-range area of several meters to several tens of meters via the first antenna 110. A user who is positioned in the short-range area receives the affiliated store ID information emitted via the first antenna 110 of the NFC device 100 through the mobile UE 300 which the user carries with him/herself.

The simple payment application 310 which is run in the mobile UE 300 receiving the affiliated store ID information transmits the client ID information to the NFC device 100 via the product information receiver 311. Then, the client ID information received via the first antenna 110 of the NFC device 100 is transmitted to the management server 400 via the affiliated store payment terminal 200.

Then the management server 400 provides information regarding products to the mobile UE 300 corresponding to the client ID information. The information regarding products is received by the product information receiver 311 of the simple payment application 310 which is run in the mobile UE 300.

In this case, the management server 400 may be configured to directly provide the information regarding products to the mobile UE 300 through wireless communication such as 3G, LTE, or Wi-Fi, or configured to relay the information regarding products to the mobile UE 300 via the affiliated store payment terminal 200.

The order request unit 312 generates order information by receiving at least one product menu selected from the information regarding products, which is received by the product information receiver 311, from a user, and transmits the generated order information via the first antenna 110 of the NFC device 100.

The affiliated store payment terminal 200 receiving the order information from the NFC device 100 stores the order information, generates a payment selection event and transmits the payment selection event to the NFC device 100 when payment for the order information is selected by a franchiser. The NFC device 100 receiving the payment selection event from the affiliated store payment terminal 200 causes the switch 130 to switch to the second antenna 120.

The payment performing unit 313 determines a distance to the NFC device 100, runs a payment interface (not shown) when the mobile UE 300 enters an ultra-short-range area, receives payment information from a user via the payment interface, transmits the payment information via the second antenna 120 of the NFC device 100, and receives a result of authorizing the payment information from the NFC device 100.

When the mobile UE 300 transmitting the order information enters the ultra-short-range area, the mobile UE 300 provides the payment interface via the payment performing unit 313 of the simple payment application 310, and receives the payment information from a user and transmits the payment information via the payment interface. In this case, the payment information may include card information including a card number, the amount of money to be paid, etc.

The payment information transmitted by the payment performing unit 313 of the simple payment application 310 is transmitted to the affiliated store payment terminal 200 via the second antenna 120 of the NFC device 100. The affiliated store payment terminal 200 relays the payment information to the VAN server 500 to request authorization for the payment information.

The VAN server 500 handles authorization for the payment information requested by the mobile UE 300 and relayed via the affiliated store payment terminal 200, and transmits a result of handling authorization for the payment information to the affiliated store payment terminal 200.

The affiliated store payment terminal 200 receiving the result of handling authorization for the payment information from the VAN server 500 transmits the result of handling authorization for the payment information to the mobile UE 300 via the second antenna 120 of the NFC device 100. Then the payment performing unit 313 of the simple payment application 310 receives and displays the result of handling authorization for the payment information.

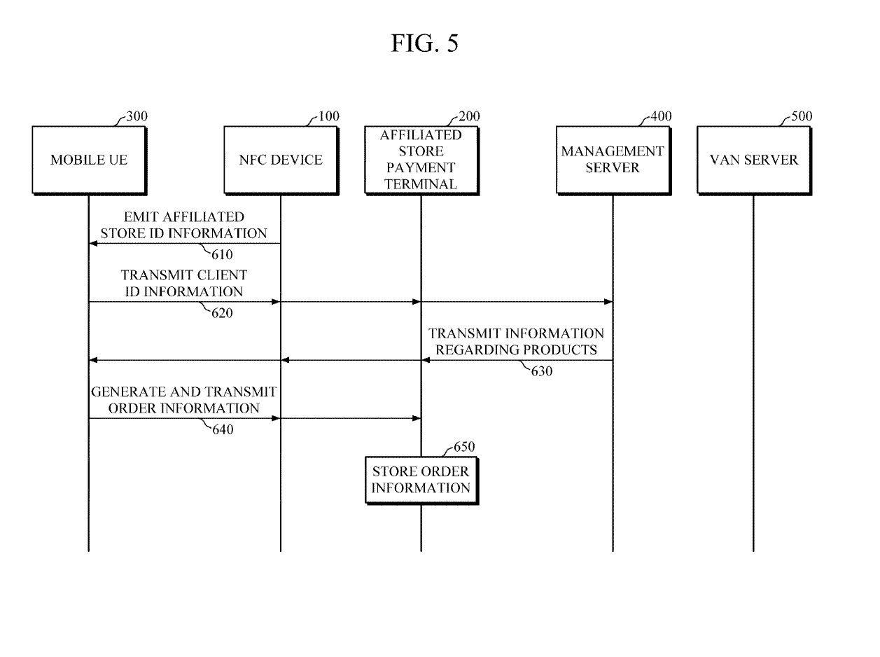

An order procedure performed by a simple mobile payment system according to an exemplary embodiment of the present invention as described above will be described with reference to FIG. 5 below. FIG. 5 is a flowchart illustrating an order procedure performed by a simple mobile payment system according to an exemplary embodiment of the present invention.

First, in operation S610, an NFC device 100 emits affiliated store ID information to a short-range area of several meters to several tens of meters via a first antenna thereof.

Then, in operation S620, a mobile UE 300 receiving the affiliated store ID information in the short-range area transmits client ID information. The client ID information transmitted from the mobile UE 300 is received via the first antenna of the NFC device 100, and is transmitted to the management server 400 via the affiliated store payment terminal 200.

In operation S630, the management server 400 provides information regarding products to the mobile UE 300 corresponding to the client ID information. In this case, the management server 400 may be configured to directly transmit the information regarding products to the mobile UE 300 through wireless communication such as 3G, LTE, or Wi-Fi, or may be configured to relay the information regarding products to the mobile UE 300 via the affiliated store payment terminal 200.

In operation S640, the mobile UE 300 generates order information by receiving at least one product menu selected from the information regarding products from a user, and transmits the generated order information to the affiliated store payment terminal 200 via the first antenna of the NFC device 100.

In operation S650, the affiliated store payment terminal 200 receiving the order information stores the order information, thereby completing the order procedure.

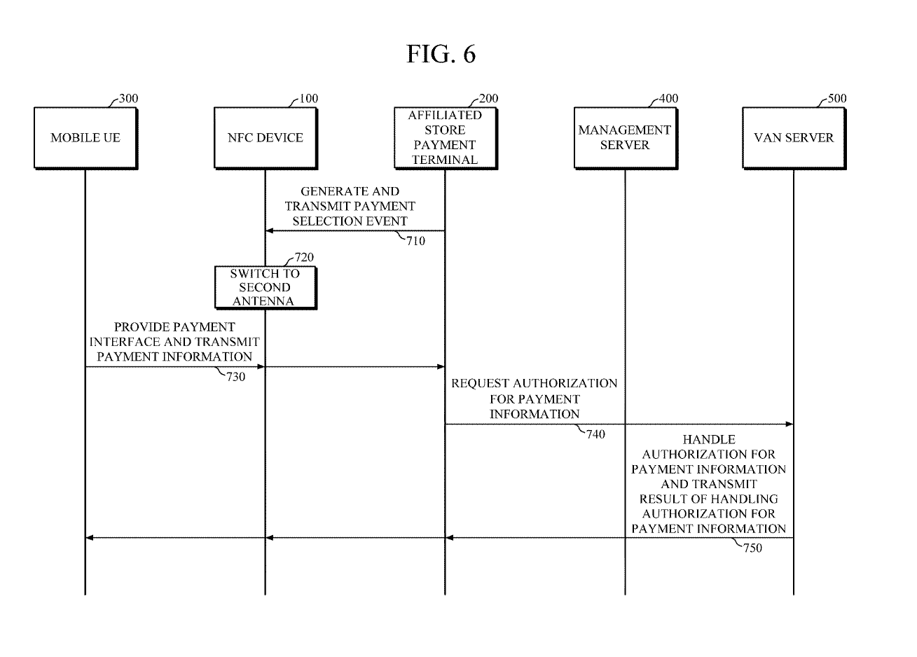

A payment procedure performed by a simple mobile payment system according to an exemplary embodiment of the present invention as described above will be described with reference to FIG. 6 below. FIG. 6 is a flowchart illustrating a payment procedure performed by a simple mobile payment system according to an exemplary embodiment of the present invention.

First, in operation S710, an affiliated store payment terminal 200 storing order information generates a payment selection event and transmits it to an NFC device 100 when payment for the order information is selected by a franchiser.

Then, in operation S720, the NFC device 100 receiving the payment selection event causes a switch to switch to a second antenna thereof.

In operation S730, when a mobile UE 300 transmitting the order information enters an ultra-short-range area in this state, the mobile UE 300 provides a payment interface via a simple payment application 310, and receives payment information from a user and transmits the payment information via the payment interface. The payment information is transmitted to the affiliated store payment terminal 200 via the second antenna of the NFC device 100.

Then, in operation S740, the affiliated store payment terminal 200 receives the payment information and relays it to the VAN server 500 to request authorization for the payment information.

Then, in operation S750, the VAN server 500 handles authorization for the payment information relayed by the affiliated store payment terminal 200, and transmits a result of handling authorization for the payment information to the affiliated store payment terminal 200.

The result of handling authorization for the payment information is transmitted to the NFC device 100 via the affiliated store payment terminal 200, and is transmitted to the mobile UE 300 via the second antenna of the NFC device 100. Then the simple payment application 310 receives and displays the result of handling authorization for the payment information.

Accordingly, according to an embodiment of the present invention, two NFC antennae are included in one NFC device to link the NFC device to an affiliated store payment terminal and mobile order and payment are handled in an easy and simple manner by switching between the two NFC antennae using a switching technique. Accordingly, system complexity and manufacturing costs may be decreased, thereby achieving the above purpose of the present invention.

According to an embodiment of the present invention, two NFC antennae are included in one NFC device to link the NFC device to an affiliated store payment terminal and mobile order and payment are handled in an easy and simple manner by switching between the two NFC antennae using a switching technique, thereby decreasing system complexity and manufacturing costs.

The present invention is industrially applicable in the field of simple mobile payment technology and applications thereof.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A simple mobile payment system including a near-field communication (NFC) device, the NFC device comprising:
a first antenna configured to cover a short-range area of several meters to several tens of meters as effective signal coverage;
a second antenna configured to cover an ultra-short-range area of several centimeters to several tens of centimeters as effective signal coverage which is smaller than the effective signal coverage of the first antenna;
a switch configured to switch between the first antenna and the second antenna; and
a switch control unit configured to output an antenna switch command to switch to the second antenna when a payment selection event is received from an affiliated store payment terminal, and output an antenna switch command to switch to the first antenna when a payment end event is received from the affiliated store payment terminal.

2. The simple mobile payment system of claim 1, wherein the NFC device further comprises a transmission power control unit configured to limit transmission power of the first antenna and the second antenna.

3. The simple mobile payment system of claim 1, wherein the first antenna emits affiliated store identification (ID) information to the short-range area.

4. The simple mobile payment system of claim 3, wherein the first antenna receives client ID information from a mobile user equipment (UE) which receives the affiliated store ID information in the short-range area.

5. The simple mobile payment system of claim 4, wherein the first antenna emits information regarding products to the mobile UE corresponding to the client ID information in the short-range area, and receives order information from the mobile UE receiving the information regarding products.

6. The simple mobile payment system of claim 1, wherein the second antenna receives payment information from the ultra-short-range area.

7. The simple mobile payment system of claim 1, wherein the NFC device is configured in the form of signpad.

8. The simple mobile payment system of claim 1, wherein the NFC device is configured in the form of dongle.

9. The simple mobile payment system of claim 1, further comprising an affiliated store payment terminal comprising:
an event generator configured to generate the payment selection event or the payment end event; and
an event transmitter configured to transmit the payment selection event or the payment end event generated by the event generator to the NFC device.

10. The simple mobile payment system of claim 9, wherein the affiliated store payment terminal further comprises an information provider configured to receive client ID information from the NFC device, relay the client ID information to a management server, receive information regarding products corresponding to the client ID information from the management server, and transmit the information regarding products to the NFC device.

11. The simple mobile payment system of claim 10, wherein the information regarding products comprises product menu information, point information, discount information, and coupon information.

12. The simple mobile payment system of claim 10, wherein the affiliated store payment terminal further comprises an order processor configured to store order information when the order information is received from the NFC device, and requests the event generator to generate the payment selection event when payment for the order information is selected by a franchiser.

13. The simple mobile payment system of claim 12, wherein the affiliated store payment terminal further comprises a payment processor configured to receive payment information from the NFC device, handle authorization for the payment information, transmit a result of handling authorization for the payment information to the NFC device, and request the event generator to generate the payment end event after payment is made.

14. The simple mobile payment system of claim 1, further comprising a mobile user equipment (UE) configured to run a simple payment application which operates in an order mode when the mobile UE is positioned in the short-range area and operates in a payment mode when the mobile UE is positioned in the ultra-short-range area.

15. The simple mobile payment system of claim 14, wherein the simple payment application comprises:
a product information receiver configured to transmit client identification (ID) information to the NFC device and receive information regarding products from a management server when affiliated store ID information is received via the first antenna of the NFC device;
an order request unit configured to generate order information by receiving at least one product menu selected from the information regarding products, which is received by the product information receiver, from a user, and to transmit the generated order information via the first antenna of the NFC device; and
a payment performing unit configured to determine a distance to the NFC device, run a payment interface when the mobile UE enters the ultra-short-range area, receive payment information from the user via the payment interface, transmit the payment information via the second antenna of the NFC device, and receive a result of authorizing payment from the NFC device.
